(19) United States
(12) Patent Application Publication
(10) Pub. No.: US 2017/0049657 A1
(43) Pub. Date: Feb. 23, 2017

(54) Rehabilitative Glove Device

(71) Applicant: Jane Cortez, Northridge, CA (US)

(72) Inventor: Jane Cortez, Northridge, CA (US)

(21) Appl. No.: 14/829,768

(22) Filed: Aug. 19, 2015

(51) Int. Cl. A61H 1/02

(52) U.S. Cl. CPC A61H 1/0288; A61H 2201/165; A61H 2205/067

(57) ABSTRACT

A rehabilitative glove device includes a shell that is hand shaped. The shell is flexible and has a top face, a bottom face, a first end and a second end. The first end comprises a set of five tubes. The second end comprises a collar that is open. A power module is coupled to and positioned in the collar. A splitter is coupled to and positioned in a compartment positioned on the shell. The device comprises a set of five tension bands operationally coupled to the splitter. The tension bands extend from the compartment along one of the five tubes. The second terminus of each the tension bands is coupled proximate to the tip of one of the tubes. A control panel positioned on the collar is operationally coupled to the power module, and, via a cable positioned on the top face, to the splitter.

### BACKGROUND OF THE DISCLOSURE

### Field of the Disclosure

The disclosure relates to glove devices and more particularly pertains to a new glove device for assisting rehabilitative movement of the hand.

### SUMMARY OF THE DISCLOSURE

An embodiment of the disclosure meets the needs presented above by generally comprising a shell that is hand shaped. The shell is flexible and has a top face, a bottom face, a first end and a second end. The first end comprises a set of five tubes. The second end comprises a collar that is open.

A power module is coupled to and positioned in the collar. A splitter is coupled to and positioned in a compartment positioned on the shell. The device comprises a set of five tension bands operationally coupled to the splitter. The tension bands extend from the compartment along one of the five tubes. The second terminus of each the tension bands is coupled proximate to the tip of one of the tubes. A control panel positioned on the collar is operationally coupled to the power module, and, via a cable positioned on the top face, to the splitter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a rehabilitative glove device according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure.

FIG. 5 is an in-use view of an embodiment of the disclosure.

### DESCRIPTION OF THE PREFERRED EMBODIMENT

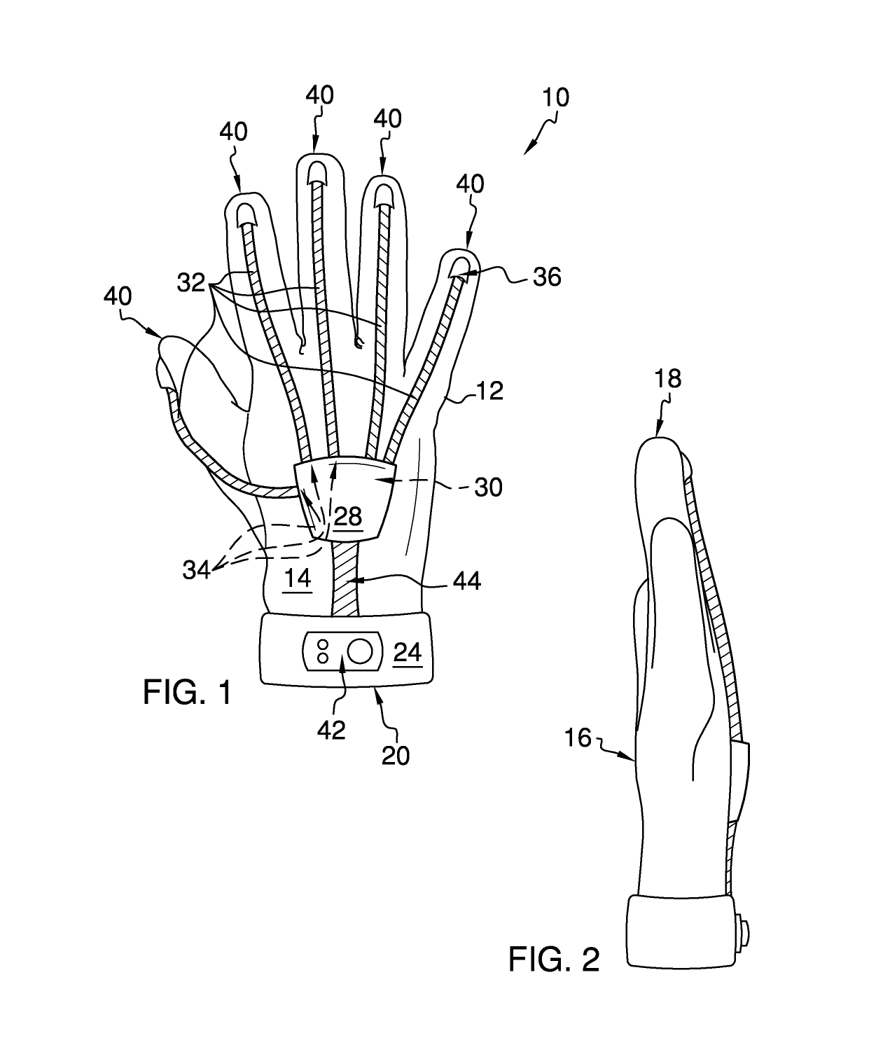

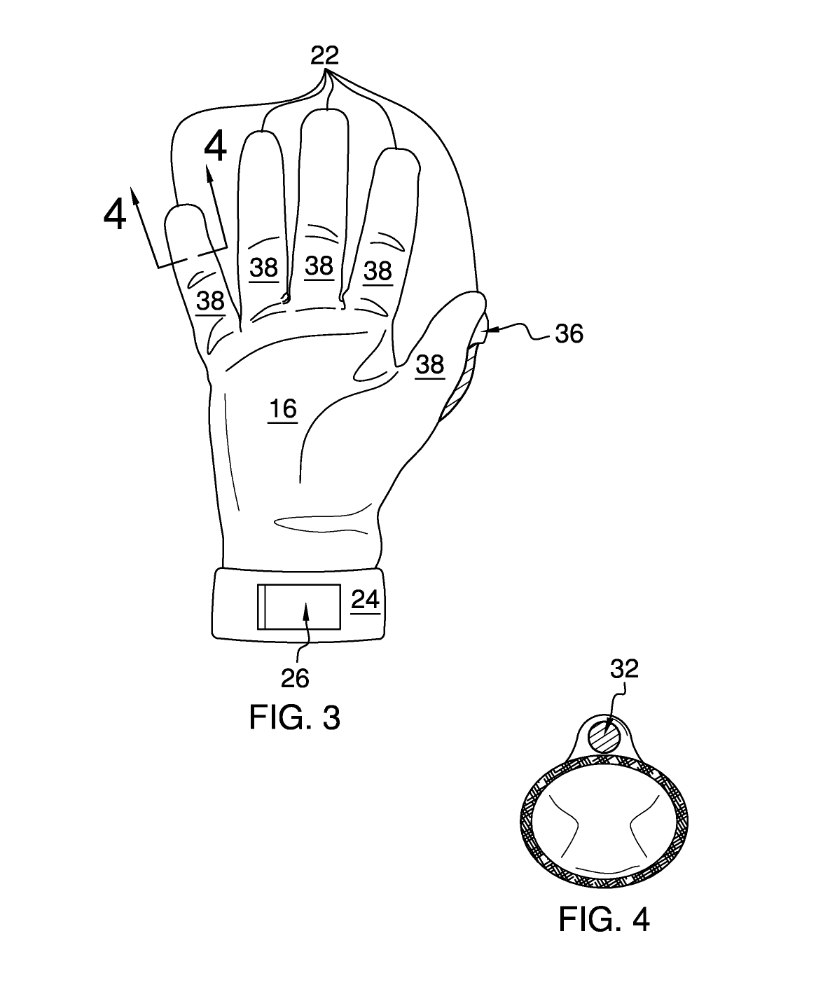

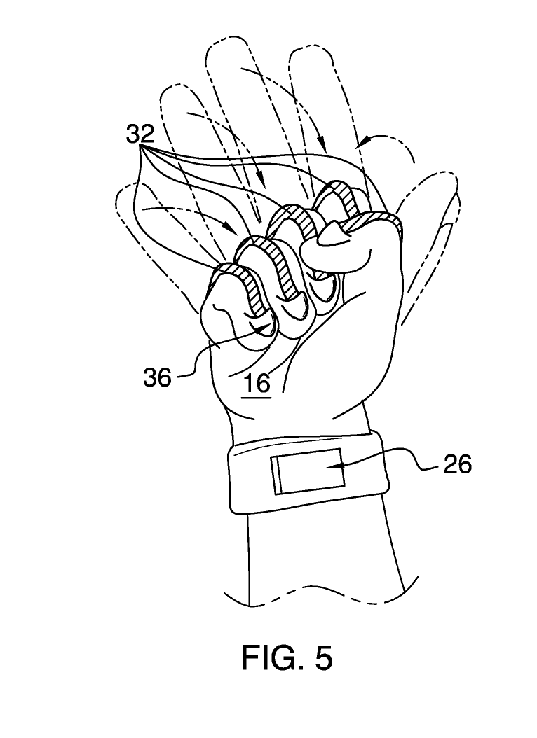

With reference now to the drawings, and in particular to FIGS. 1 through 5 thereof, a new glove device embodying the principles and concepts of an embodiment of the disclosure and generally designated by the reference numeral 10 will be described.

As best illustrated in FIGS. 1 through 5, the rehabilitative glove device 10 generally comprises a shell 12 that is hand shaped. The shell 12 is flexible and has a top face 14, a bottom face 16, a first end 18 and a second end 20. The first end 18 comprises a set of five tubes 22. The second end 20 comprises a collar 24 that is open, such that the shell 12 is configured to receive a hand inserted through the collar 24 positioning the fingers and thumb of the hand into the tubes 22. A power module 26 is coupled to and positioned in the collar 24. The power module 26 comprises at least one battery. The power module 26 is coupled to and positioned in the collar 24 on the bottom face 16. A compartment 28 is positioned on the top face 14. A splitter 30 is coupled to and positioned in the compartment 28.

The device 10 also comprises a set of five tension bands 32. Each of the tension bands 32 has respectively a first terminus 34 and a second terminus 36. The first terminus 34 of each tension band 32 is operationally coupled to the splitter 30. Each tension band 32 extends from the compartment 28 across the top face 14 and along a respective one of the five tubes 38. The second terminus 36 of each tension band 32 is coupled proximate to the tip 40 of the respective one of the tubes 38. The tension bands 32 are metal. A control panel 42 is operationally coupled to the power module 26 and the splitter 30. The control panel 42 is positioned on the collar 24 on the top face 14. A cable 44 is positioned on the top face 14 and operationally coupled to the splitter 30 and to the control panel 42. The cable 44 is metal.

In use, the control panel 42 draws power from the power module 26 and transfers the power and user commands through the cable 44 to the splitter 30, wherein the set of five tension bands 32 are urged to assist movement of the hand of the user. The control panel 42 can accept user commands to urge the five tension bands 32 to assist the hand of the user in forming a fist, to assist in opening the hand from a fisted position, to assist in spreading the fingers and thumb positioned in the set of five tubes 22 from parallel alignment, or to assist in bringing the fingers and thumb positioned in the set of five tubes 22 from a spread position into parallel alignment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rehabilitative glove device comprising:
a shell, said shell being hand shaped, said shell being flexible, said shell having a top face, a bottom face, a first end and a second end, said first end comprising a set of five tubes, said second end comprising a collar, said collar being open, wherein said shell is configured to receive a hand inserted through said collar positioning the fingers and thumb of the hand into said tubes;
a power module, said power module being coupled to and positioned in said collar;
a compartment, said compartment being positioned on said shell;
a splitter, said splitter being coupled to and positioned in said compartment;
a set of five tension bands, each of said tension bands having respectively a first terminus and a second terminus, said first terminus of each said tension band being operationally coupled to said splitter, each of said tension bands extending from said compartment across said top face and along a respective one of said five tubes, said second terminus of each said tension band being coupled proximate to the tip of said respective one of said tubes;
a control panel, said control panel being operationally coupled to said power module and said splitter;
a cable, said cable being positioned on said top face and operationally coupled to said splitter and to said control panel; and
wherein said control panel draws power from said power module and transfers the power and user commands through said cable to said splitter, wherein said set of five tension bands are urged to assist movement of the hand of the user.

2. The device of claim 1, further including said power module comprising at least one battery.

3. The device of claim 1, further comprising:
said power module being coupled to and positioned in said collar on said bottom face;
said compartment being positioned on said top face; and
said control panel being positioned on said collar on said top face.

4. The device of claim 1, further including said tension bands and said cable being metal.

5. A rehabilitative glove device comprising:
a shell, said shell being hand shaped, said shell being flexible, said shell having a top face, a bottom face, a first end and a second end, said first end comprising a set of five tubes, said second end comprising a collar, said collar being open, wherein said shell is configured to receive a hand inserted through said collar positioning the fingers and thumb of the hand into said tubes;
a power module, said power module being coupled to and positioned in said collar, said power module comprising at least one battery, said power module being coupled to and positioned in said collar on said bottom face;
a compartment, said compartment being positioned on said top face;
a splitter, said splitter being coupled to and positioned in said compartment;
a set of five tension bands, each of said tension bands having respectively a first terminus and a second terminus, said first terminus of each said tension band being operationally coupled to said splitter, each of said tension bands extending from said compartment across said top face and along a respective one of said five tubes, said second terminus of each said tension band being coupled proximate to the tip of said respective one of said tubes, said tension bands being metal;
a control panel, said control panel being operationally coupled to said power module and said splitter, said control panel being positioned on said collar on said top face;
a cable, said cable being positioned on said top face and operationally coupled to said splitter and to said control panel, said cable being metal; and
wherein said control panel draws power from said power module and transfers the power and user commands through said cable to said splitter, wherein said set of five tension bands are urged to assist movement of the hand of the user.
